(19) United States
(12) Patent Application Publication
(10) Pub. No.: US 2007/0013468 A1
(43) Pub. Date: Jan. 18, 2007

(54) Means to increase or decrease magnetic strength in permanent magnetic clamping devices

(76) Inventor: Ian Godfrey Heard, Sydney (AU)

Correspondence Address: SERPENT AND DOVE PTY LTD, UNIT 6-32 CAMPBELL AVENUE, CROMER NSW, 2099, AU

(21) Appl. No.: 11/473,901

(22) Filed: Jun. 26, 2006

Related U.S. Application Data
(60) Provisional application No. 60/699,993, filed on Jul. 18, 2005.

(51) Int. Cl. H01F 7/08

(52) U.S. Cl. 335/228

(57) ABSTRACT

A mechanical means to increase or decrease the magnetic strength of magnetic clamping devices used to clamp ferromagnetic workpieces together.

### CROSS-REFERENCE TO RELATED APPLICATIONS

The present Utility Patent application claims priority benefit of the U.S. Provisional application for Patent No. 60/699,993 filed on Jul. 18/2005 under 35 U.S.C 119(e)

### FIELD OF THE INVENTION

The invention pertains to permanent magnetic work-holding and clamping devices as used for magnetically clamping ferromagnetic workpieces during welding or other joining processes.

### BACKGROUND OF THE INVENTION

The invention pertains to magnetic clamping devices of the type employing two ferromagnetic pole plates having between them a magnetizing element of ferrite, neodymium, alnico or other material with its magnetized orientation through its thickness. Such devices provide magnetic flux across the air gap between the ferromagnetic pole plates that is useful for gripping ferromagnetic workpieces. Because of the permanently ‘on’ condition of such devices they may be difficult to remove from the workpieces which they clamp or difficult to manipulate. There is therefore a need for a magnetic clamping device that permits easier set-up of workpieces and easier removal of the clamping device from the workpieces. The current invention describes a method for both decreasing or increasing the amount of magnetic flux available at the ferromagnetic pole edges. A decrease in available flux enables workpieces more easily to be positioned or the clamping device to be manipulated or removed. An increase maximises clamping effect on the workpieces.

### DETAILED DESCRIPTION OF THE DRAWINGS

The present invention is illustrated by way of example, and not by way of limitation, in the figures of the accompanying drawings and in which like reference numerals refer to similar elements and in which:

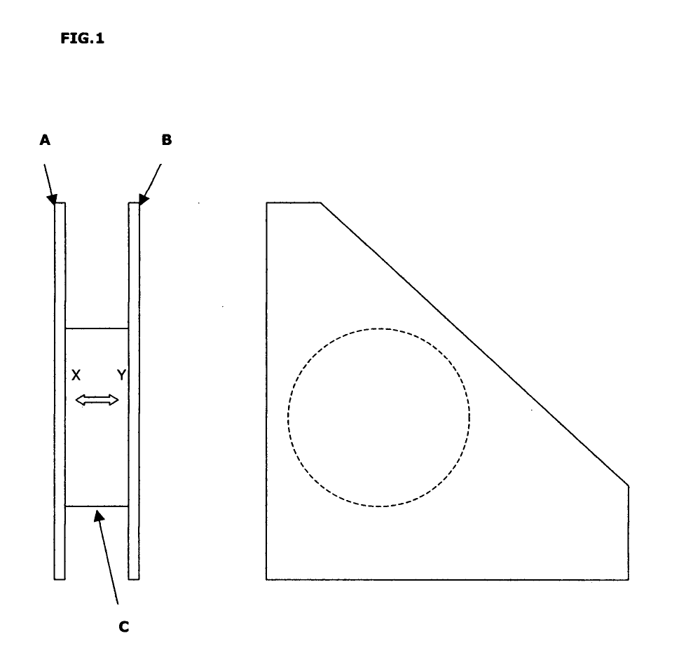

FIG. 1 illustrates a typical magnetic clamping device consisting of two ferromagnetic pole plates, items A and B. Between the pole plates is the magnetizing element or elements, item C which may be any magnetized material of the ferrite, alnico or rare earth types, magnetized in the direction shown by the X-Y axis. Pole plates A and B serve to carry the available magnetic flux to the extremities of the pole plates and provide a north and south pole at the edges of these pole plates. Magnetic flux is concentrated across the relatively narrow air-gap between the pole plates, providing good clamping force.

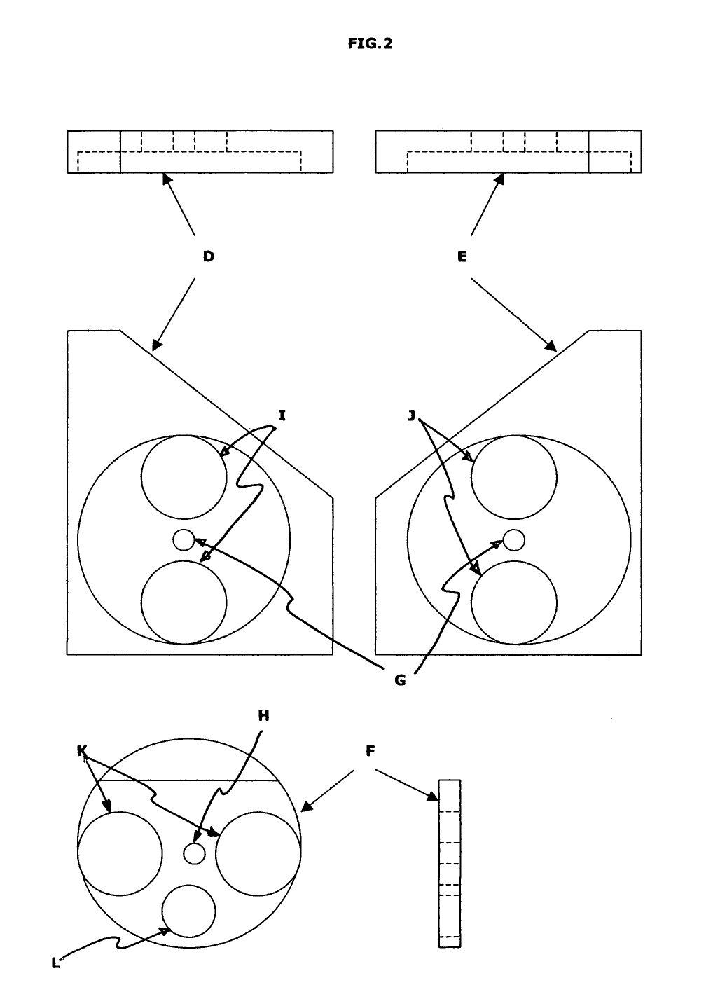

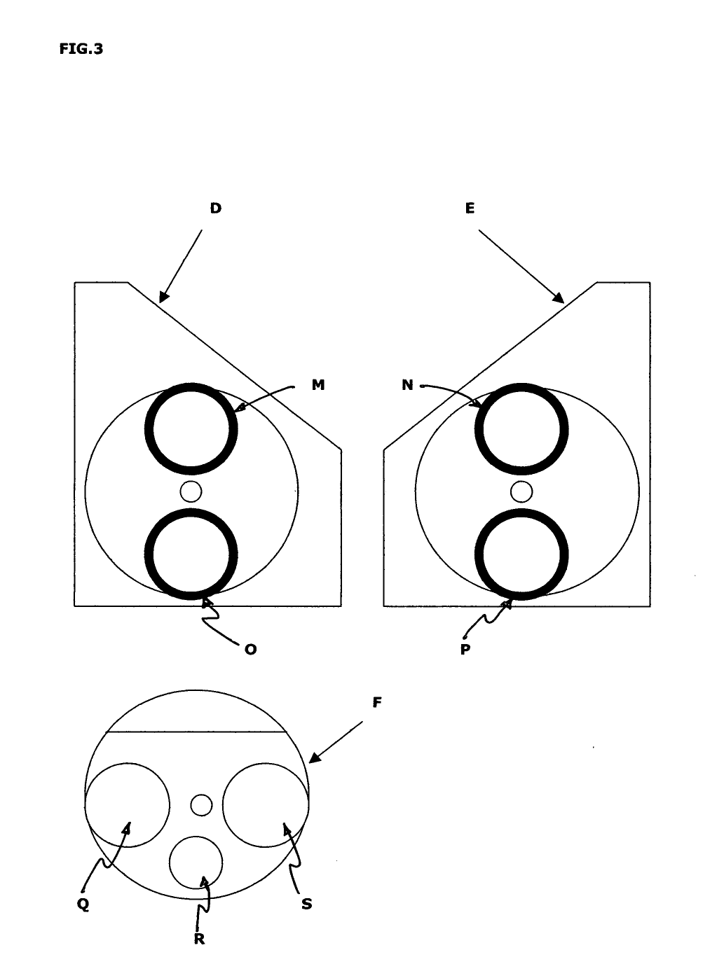

FIG. 2 shows a three-part device to house the magnetizing element or elements between the above referenced pole plates items A and B and featuring a non-magnetic rotatable inner component item F. Items D and E are mirror image housings of non-magnetic material and are put together to form an enclosure housing item F and for placement between the pole plates, items A and B (of FIG. 1) of the clamping device. Holes items I and J are for ferromagnetic inserts items M, N, O, P illustrated in FIG. 3, holes items K and L in the rotatable component are to house magnetizing elements. Rotatable component item F is housed within the hollow sections of items D and E and rotates by means of attachment in hole item H to a non-magnetic shaft (not shown for clarity) which passes through holes G when the two mirror image parts items D and E are put together to form an enclosure. The three-part device is preferably made of plastic or other non-magnetizable material.

FIG. 3. In this illustration, Items M, N, O and P are soft iron or steel, or other suitable ferromagnetic material inserts in the form of a sleeve, block or cup-shaped insert fitted within holes items I and J (see FIG. 2). These inserts are of such size that their innermost edges are able to make contact with magnetizing elements items Q and S which are inserted in the rotatable item F with like magnetic orientation, and at their outer end, make contact with pole plates items A and B of FIG. 1, conducting magnetic flux to the said pole plates. Item R is another magnetizing element (or elements) inserted in hole item L of rotatable item F, having its magnetic polarity in the opposite direction to that of Items Q and S. (All magnetizing elements are magnetized through their thickness). When the rotatable element item F is turned so that items Q and S are in contact with inserts M, N, 0 and P the apparatus exhibits maximum magnetic strength at the edges of the pole plates. When the rotatable element item F is turned so that Item R is positioned above one or other of the ferromagnetic inserts items M, N, 0, P, magnetic strength is minimized.

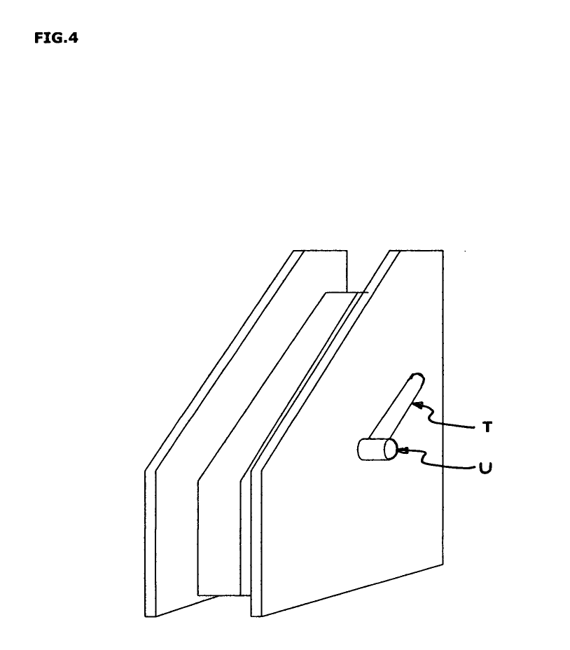

FIG. 4 shows the complete device assembled and an appropriate lever, Item T, to turn the rotatable component on its shaft, item U when in use.

What is claimed is:

1. A magnetic clamping device of the type employing a magnetizing element between two or more ferromagnetic pole plates having within it a rotatable element of non-magnetic material said rotatable element being rotatable in the same plane as the ferromagnetic pole plates and having within the rotatable element one or more axially magnetizing elements.

2. The apparatus of claim 1 having more than one magnetizing element within the non-magnetic rotatable element at least one of which has its magnetic polarity in the opposite direction to the others.

3. The apparatus of claims 1 and 2 having a housing of non-magnetic material to enclose the rotatable element such housing containing one or more soft iron or other ferromagnetic pieces arranged through its thickness so as to conduct magnetic flux from the magnetizing components within the rotatable element to the ferromagnetic pole plates.

4. The apparatus of claim 3 where the soft iron or other ferromagnetic flux-conducting pieces are solid.

5. The apparatus of claim 4 where the soft iron or other ferromagnetic flux-conducting pieces are cylindrical.

6. The apparatus of claim 4 where the soft iron or other ferromagnetic flux-conducting pieces are cup-shaped.

7. The apparatus of claim 4 where the soft iron or other ferromagnetic flux-conducting pieces are cup-shaped with a hole in the closure section of the cup-shaped piece.
